(19) United States
(12) Patent Application Publication
(10) Pub. No.: US 2010/0144345 A1
(43) Pub. Date: Jun. 10, 2010

(54) USING CALLED PARTY MOBILE PRESENCE AND MOVEMENT IN COMMUNICATION APPLICATION

(75) Inventors: Alexander Darrow, Seattle, WA (US); Alexander M. Hehmeyer, Bellevue, WA (US); Marcelo D. Truffat, Woodinville, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/330,977

(22) Filed: Dec. 9, 2008

(51) Int. Cl. H04W 4/00

(52) U.S. Cl. 455/434

(57) ABSTRACT

Callers are enabled to choose among available communication modes based on information about a called party's mobile status. Mobile status information including whether or not the called party is in motion, their speed if they are in motion, a direction of their movement, as well as their location, can be received from sources such as a presence server, a GPS service, and other information sources. Inferences are made based on the received information and available and/or recommended communication modes suggested to the caller.

### BACKGROUND

While telephone technologies changed little until last decade, telecommunication services evolved substantially in a relatively short time with the importation of computing technologies into telecommunication systems and devices. Cellular telephones are an illustrative example. The services provided through a cellular phone such as video streaming, image acquisition and transfer, music distribution, financial transactions, and many others are examples of activities that would have been impossible through conventional phone technologies. As higher speed and broader bandwidth networks become available many more services are enabled by the infrastructure.

The rapid development of capabilities and services provided through communication devices are not limited to cellular phones. Newer systems combine a variety of short range and long range communication capabilities over a number of networks including traditional phone networks, wireless networks, wide area wireless Internet, and similar ones. Telecommunication end devices as well as support devices and programs for such newer systems are more similar to computer networks than conventional telephone networks. Thus, a large number of capabilities may be added to those already provided by modern telecommunication devices and networks.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing information about a called party's mobile status to a caller to enable the caller to choose among available communication modes. The mobile status may include whether or not the called party is in motion, their speed if they are in motion, a direction of their movement, a last time since their movement, as well as their location. Inferences may be made based on individual or combined mobile status information regarding availability of various communication modes and recommendations made to the caller. Mobile status information may be received from a variety of sources.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a diagram illustrating an example unified communications system;

FIG. 2 illustrates example scenarios where various communication modes may be utilized based on the called party's mobile status according to embodiments;

FIG. 3 illustrates communication application architectures on the caller and called party sides for implementing communication mode assistance based on the called party's mobile status;

FIG. 4 is a screenshot of an example communication application illustrating communication mode assistance based on the called party's mobile status;

FIG. 5 is another screenshot of an example communication application illustrating communication mode assistance based on the called party's mobile status in a different manner;

FIG. 6 is a networked environment, where a system according to embodiments may be implemented;

FIG. 7 is a block diagram of an example computing operating environment, where a communication application according to embodiments may be implemented;

FIG. 8 illustrates a logic flow diagram for using called party's mobile status in facilitating communications according to embodiments; and

FIG. 9 illustrates a logic flow diagram for determining available communication modes based on called party's mobile status according to embodiments.

### DETAILED DESCRIPTION

As briefly described above, mobile status information regarding potential called party's may be received and inferences made regarding their status such as whether they are walking, travelling in a car, travelling in a plane, and similar conditions. Available communication modes may then be determined and recommended to a caller. Additional information such as location and/or direction of movement may also be taken into consideration. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media. The computer program product may also be a propagated signal on a carrier (e.g. a frequency or phase modulated signal) or medium readable by a computing system and encoding a computer program of instructions for executing a computer process.

Throughout this specification, the term “platform” may be a combination of software and hardware components for managing traffic related data. Examples of platforms include, but are not limited to, a hosted service executed over a plurality of servers, an application executed on a single server, and comparable systems. The term “server” refers to a computing device executing one or more software programs typically in a networked environment. More detail on these technologies and example operations is provided below.

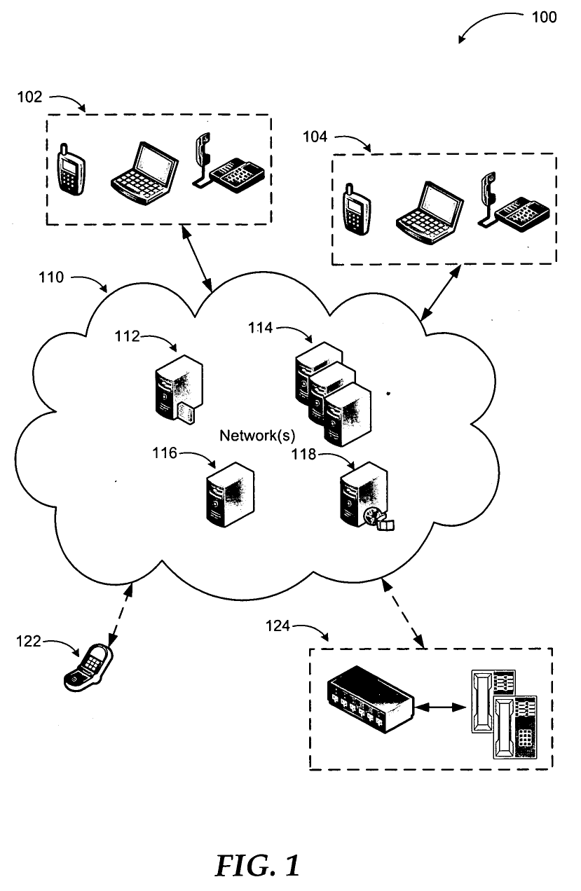

Referring to FIG. 1, diagram 100 of an example unified communications system is illustrated. A unified communication system is an example of modern communication systems with a wide range of capabilities and services that can be provided to subscribers. A unified communication system is a real-time communications system facilitating instant messaging, presence, audio-video conferencing, data sharing, application sharing, white-boarding, and web conferencing functionality.

In a unified communication (“UC”) system such as the one shown in diagram 100, users may communicate via a variety of end devices (102, 104), which are client devices of the UC system. Each client device may be capable of executing one or more communication applications for voice communication, video communication, instant messaging, application sharing, data sharing, and the like. In addition to their advanced functionality, the end devices may also facilitate traditional phone calls through an external connection such as through PBX 124 to a Public Switched Telephone Network (“PSTN”). End devices may include any type of smart phone, cellular phone, any computing device executing a communication application, a smart automobile console, and advanced phone devices with additional functionality.

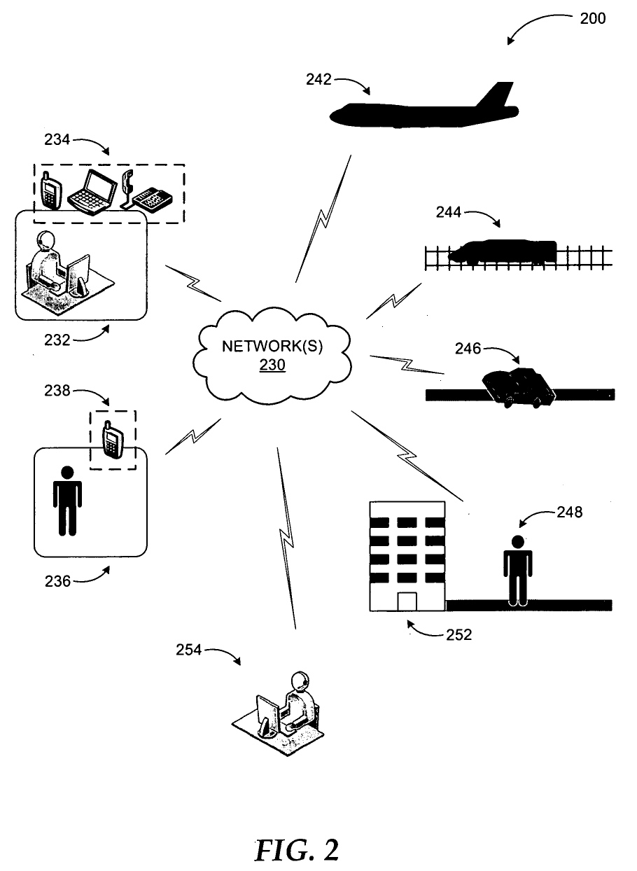

UC Network(s) 110 includes a number of servers performing different tasks. For example, UC servers 114 provide registration, presence, and routing functionalities. Presence functionality enables the system to route calls to a user to anyone of the client devices assigned to the user based on default and/or user set policies. For example, if the user is not available through a regular phone, the call may be forwarded to the user's cellular phone, and if that is not answering a number of voicemail options may be utilized. Similarly several phones (communication devices/applications) may be notified at the same time before a back up device is notified based on user provided rules. Since the end devices can handle additional communication modes, UC servers 114 may provide access to these additional communication modes (e.g. instant messaging, video communication, etc.) through access server 112. Access server 112 resides in a perimeter network and enables connectivity through UC network(s) 110 with other users in one of the additional communication modes. UC servers 114 may include servers that perform combinations of the above described functionalities or specialized servers that only provide a particular functionality. For example, home servers providing presence functionality, routing servers providing routing functionality, and so on. Similarly, access server 112 may provide multiple functionalities such as firewall protection and connectivity, or only specific functionalities as discussed in more detail in FIG. 2 below.

Audio/Video (A/V) conferencing server 118 provides audio and/or video conferencing capabilities by facilitating those over an internal or external network. Mediation server 116 mediates signaling and media to and from other types of networks such as a PSTN or a cellular network (e.g. calls through PBX 124 or from cellular phone 122). Mediation server 116 may also act as a Session Initiation Protocol (SIP) user agent (e.g. Back-to-Back User Agent “B2BUA”).

In a UC system, users may have one or more identities, which is not necessarily limited to a phone number. The identity may take any form depending on the integrated networks, such as a telephone number, a Session Initiation Protocol (SIP) Uniform Resource Identifier (URI), or any other identifier. While any protocol may be used in a UC system, SIP is a preferred method.

The SIP is an application-layer control (signaling) protocol for creating, modifying, and terminating sessions with one or more participants. It can be used to create two-party, multiparty, or multicast sessions that include Internet telephone calls, multimedia distribution, and multimedia conferences. SIP is designed to be independent of the underlying transport layer.

SIP clients may use Transport Control Protocol (“TCP”) to connect to SIP servers and other SIP endpoints. SIP is primarily used in setting up and tearing down voice or video calls. However, it can be used in any application where session initiation is a requirement. These include event subscription and notification, terminal mobility, and so on. Voice and/or video communications are typically done over separate session protocols, typically Real Time Protocol (“RTP”).

Because end devices in a UC system according to embodiments can provide and receive a variety of information about their status (hardware and/or software) and a user's status, a number of additional features may be incorporated into communication capabilities. For example, a user's availability, their preferences, and similar information may be exchanged such that a calling subscriber can choose communication options. The end devices may also receive information from other sources such as a GPS server or a cellular system device including location information for other subscribers. Thus, a calling subscriber may know before initiating a call whether or not another subscriber to be called is available, mobile or stationary, where they are, or if mobile how fast and in which direction they are headed. The information may be provided by location (or similar) information devices/systems associated with the called party or another party (e.g. the calling party) that is linked to the called party such that the location (or similar) information can be inferred and processed through the UC servers.

While the example system in FIG. 1 has been described with specific components such as mediation server, A/V server, and similar devices, embodiments are not limited to these components or system configurations and can be implemented with other system configuration employing fewer or additional components. Functionality of systems enabling use of mobile presence and movement information in selecting communication modes may also be distributed among the components of the systems differently depending on component capabilities and system configurations.

FIG. 2 illustrates example scenarios in diagram 200, where various communication modes may be utilized based on the called party's mobile status according to embodiments. Mobile status, as used herein, is not limited to whether or not a called party is stationary or in motion, but it also includes information about a direction of the called party, a speed of the called party, and a location of the called party.

As discussed above, modern communication technologies such as UC services enable subscribers to utilize a wide range of computing device and application capabilities in conjunction with communication services. This means, a subscriber may use one or more devices (e.g. a regular phone, a smart phone, a computer, a smart automobile console, etc.) to facilitate communications. Depending on the capabilities of each device and applications available on each device, additional services may be enabled in conjunction with the available communications. Furthermore, a variety of communication modes such as voice communication, video communication, instant messaging, electronic mail, data sharing, application sharing, white-boarding, and similar modes, may be available depending on the capabilities of each device and applications available on each device.

Thus, a subscriber 232 of a unified communication system in a location such as an office may have multiple devices and applications available for communication as illustrated by reference numeral 234. These may include communication applications executed on a laptop computer or a desktop computer, a smart phone, and a regular telephone. Another subscriber 236 may be moving and have only his/her smart phone or cellular phone (238) available for communications. Since subscriber 232 is likely to have more applications available on his/her computing devices, most of the above listed communication modes may be available to that subscriber. On the other hand, subscriber 236 has only a single device available with limited capabilities. So, subscriber 236 may have only voice communication and instant messaging capabilities, for example. Of course, the capabilities may vary depending on device and applications, as well as a location of the subscriber (availability of wireless services).

Mobile status of a party to be called may include stationary 254 (e.g. in the office), walking 248, travelling in a slow moving vehicle such as a car 246, travelling in a fast moving vehicle such as a high speed train 244, and travelling in a very high speed vehicle such as a plane 242. The mobile status information in each of these scenarios may be made available to the calling subscriber upon request or through automatic means (e.g. mobile status of a select number of subscribers may be continuously provided to the calling subscriber). The status information may be obtained from one or more of the communication device of the parties to be called, a GPS server, and other resources associated with network(s) 230.

Upon receiving the mobile status information for a subscriber to be called, the communication application on the calling subscriber's device (or a separate application) may determine available and/or recommended communication modes for the subscriber to be called and present them to the calling subscriber. Based on the information, the calling subscriber may select one communication mode over the others, or select other actions such as calling an alternative contact. For example, the mobile status information for a subscriber to be called may indicate that he/she is walking toward his/her office building. Recognizing that, the calling subscriber may opt to wait before initiating a video call with that subscriber. According to another example, the mobile status of the subscriber to be called may indicate that they are in a vehicle. Recognizing that the instant message or electronic mail options for that subscriber may be removed or de-emphasized when presenting to the calling subscriber.

Conversely, movement may be used to help promote communication. For example, if the called party is at a conference and stationary most of the time, the caller could opt to be notified when the called party starts to walk around because they know the called party is out of a certain session. Moreover, a tagging feature may be implemented at a mobile presence server such that the calling party is notified when the called party is moving (or not moving) depending on the circumstances.

Further actions that may be available through the utilization of mobile status information may include setting of remote communication parameters. For example, if the calling subscriber knows the called subscriber is in an automobile, a hands free operation mode may be automatically activated on the called subscriber's device even if that subscriber forgot to activate the hands free operation. Other parameters that may be set remotely based on the mobile status information may include parameters associated with level and quality of sound or images.

Speed and location of a called party are discussed throughout this specification as examples of called party mobile status. However, the mobile status is a broader concept that may be inferred from information about speed and location, among other things. For example, location refers to geospatial position such as defined by latitude, longitude (or even altitude) and speed indicates a rate of change in the called party's location. Other sources of information that may be utilized in determining mobile status may include environment (e.g. office, car, home, which are distinct from geospatial position, but may be related). The environment may be determined through sources such as connection of the called party's device to a particular network, an operating mode of the device (e.g. airplane mode), etc. and is not limited to determination from GPS or similar location-based information sources. Similarly, a type of device used by the called party may help determine the mobile status of the called party (e.g. if the called party is using a desktop computer, he/she is unlikely to be walking outdoors). Thus, embodiments are not limited to geospatial position and other sources of information discussed herein. Any source of information that may assist in determining a mobile status of the called party may be employed using the principles discussed herein.

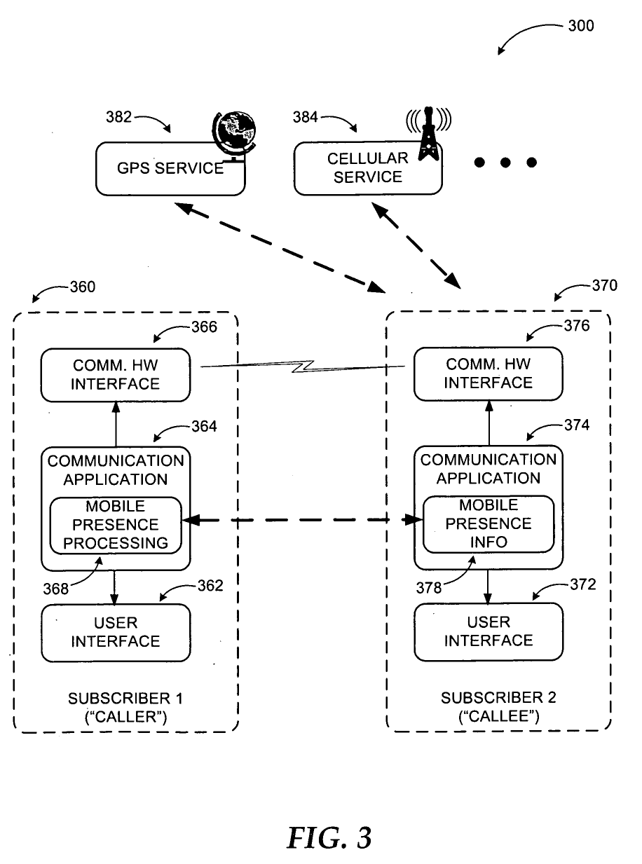

FIG. 3 illustrates diagram 300 of communication application architectures on the caller and called party sides for implementing communication mode assistance based on the called party's mobile status. Communication applications providing enhanced communications and associated services may be individual applications executed on end devices interacting with other applications or they may be part of a hosted service remotely providing the services to connected subscribers.

On the called subscriber (370) side, communication application 374 may include a mobile presence information module 378 for obtaining information related to a mobile status of the subscriber 2 such as whether or not the subscriber is in motion, a speed and direction of the motion, a location of the subscriber and similar information. The information may be obtained from local or remote resources such as GPS service 382, cellular service 384, local gyro-sensors (not shown), wireless network identifiers, and comparable resources. For example, a called party may be connected to a LAN in an airplane and that information may be shared with the calling party. Mobile presence information may then be published based on the mobile status of the subscriber to make other subscribers aware of the current status of subscriber 2. User interface 372 may be used to enable subscriber 2 to enter additional information, make selections, and so on. For example, subscriber 2 may choose not to have a particular communication mode enabled despite that mode being available as default in a certain mobile status. Communication hardware interface 376 provides connection with available hardware components such as transceivers for various communication modes to communication application 374.

On the calling subscriber 1 (360) side, a parallel structure includes communication hardware interface 366, user interface 362, and communication application 364. Mobile presence processing module 368, which may be a separate application or part of communication application 364, is configured to receive the mobile presence information from subscriber 2 and determine which communication mode(s) can be enabled/recommended to subscriber 1 through user interface 362. The link between the mobile presence modules is shown in the figure in dashed format. This is intentional, since the communication between the modules (as well as any applications) may be direct or through other intermediaries such as UC presence servers or other servers.

According to other embodiments, mobile presence processing module 368 may receive at least a portion of the information related to the mobile status of subscriber 2 from other resources and determine subscriber 2's mobile status before determining which communication modes should be enabled/recommended.

Mobile status of subscriber 2 may be computed based on speed, location, direction information using one or more algorithms such as a branch-and-bound algorithm, a progressive improvement algorithm, a heuristic algorithm, or another algorithm. Similarly, communication modes for different mobile statuses may also be determined using various algorithms and/or user inputs.

While specific computing devices and communication related tasks have been described above, these are for illustration purposes only and do not constitute a limitation on embodiments. Many other hardware environments and communication related tasks may be implemented using the principles described herein.

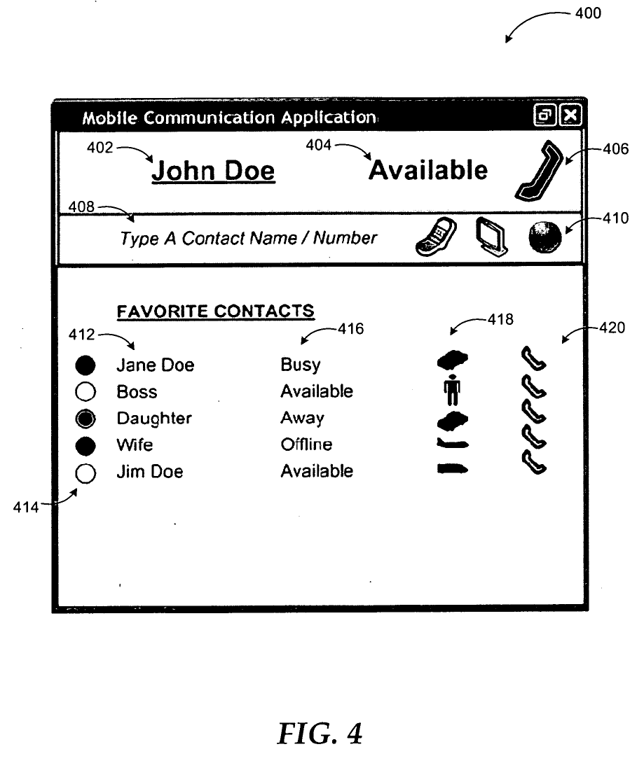

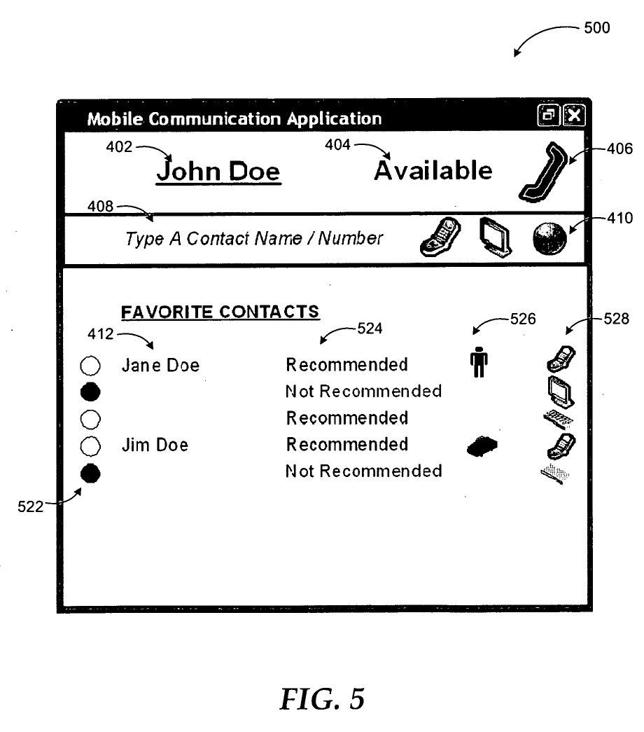

FIG. 4 is a screenshot 400 of an example communication application illustrating communication mode assistance based on the called party's mobile status. While a user interface for an application enabling subscribers facilitate various communications with other subscribers may take any form and shape, and include a variety of elements, example ones are shown in FIG. 4 and FIG. 5 to illustrate aspects of the present disclosure. For example, mobile status information may be presented in a user interface at the same prominence as available communication modes to assist a caller in making decisions.

The user interface in screenshot 400 includes the user's name (402) and current status (404) along with an icon for initiating a call (406). Also included is an input area 408 for entering a contact name or number to place a call (initiate video communication, send an instant message, and comparable communications), as well as icons of available communication modes 410 on the particular device executing the communication application.

According to one embodiment, the user interface may list a group of subscribers 412 (such as those in a favorite contacts list) along with their communication status 416. Next to the listing of communication status 416, a mobile status indication 418 for each subscriber on the list may be presented to enable the user (John Doe) to make a decision regarding establishing communication with the subscribers. The mobile status indication is shown in iconic form on screenshot 400, but it may also be presented in textual or combination of textual and graphic form. Icons 420 may indicate available communication modes or simply activate communication when one of them is clicked on. Additional graphical (or textual) elements such as radio buttons 414 may further indicate subscriber status following a color scheme or another graphical scheme.

FIG. 5 is another screenshot 500 of an example communication application illustrating communication mode assistance based on the called party's mobile status in a different manner. Elements of the user interface on screenshot 500 numbered similarly to the elements of the user interface on screenshot 400 are configured to operate in a likewise manner, and are not described further.

Differently from the user interface of FIG. 4, available communication modes 528 and mobile status 526 are displayed for each subscriber 412 in the favorite contacts list. For each graphically displayed communication mode (528), a textual indication of whether or not that mode is recommended is listed (524). The recommendation may also be displayed graphically in the radio buttons 522. Radio buttons 522 may also be used to indicate status such as available, busy, away according to a color scheme. Subscriber John Doe may activate one of the available communication modes by clicking on the corresponding icon.

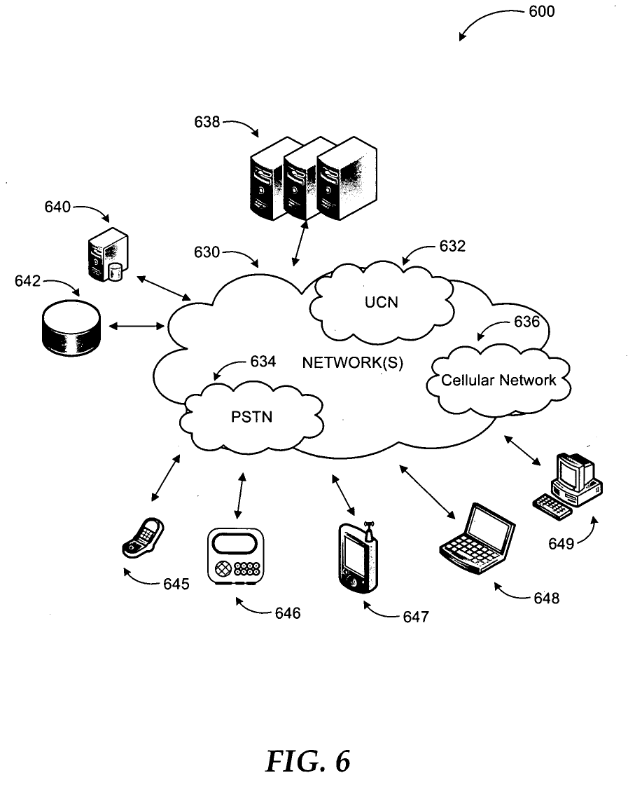

FIG. 6 is an example networked environment, where embodiments may be implemented. A platform providing unified communication services may be implemented via software executed over one or more servers 634 such as a hosted service. The platform may communicate with consuming applications on individual computing devices such as a cellular phone 645, smart automobile console 646, a handheld computer 647, a laptop computer 648, and desktop computer 649 through network(s) 630.

As discussed previously, computing devices 645-649 are used to facilitate communications through a variety of modes between subscribers of the UC service. For a subscriber calling another, mobile presence information along with movement status (e.g. speed, direction, location) may be received through a variety of means and processed to determine and recommend available modes. Information associated with subscribers and facilitating communications may be stored in one or more data stores (e.g. data store 642), which may be managed by any one of the servers 638 or by database server 640.

Network(s) 630 may comprise any topology of servers, clients, Internet service providers, and communication media. A system according to embodiments may have a static or dynamic topology. Network(s) 630 may include a secure network such as an enterprise network, an unsecure network such as a wireless open network, or the Internet. Network(s) 630 may also comprise a plurality of distinct networks such as UC network 632, PSTN 634, and cellular network 636. Network(s) 630 provides communication between the nodes described herein. By way of example, and not limitation, network(s) 630 may include wireless media such as acoustic, RF, infrared and other wireless media.

Many other configurations of computing devices, applications, data sources, and data distribution systems may be employed to implement a system for using called party mobile presence and movement data in determining available communication modes. Furthermore, the networked environments discussed in FIG. 6 are for illustration purposes only. Embodiments are not limited to the example applications, modules, or processes.

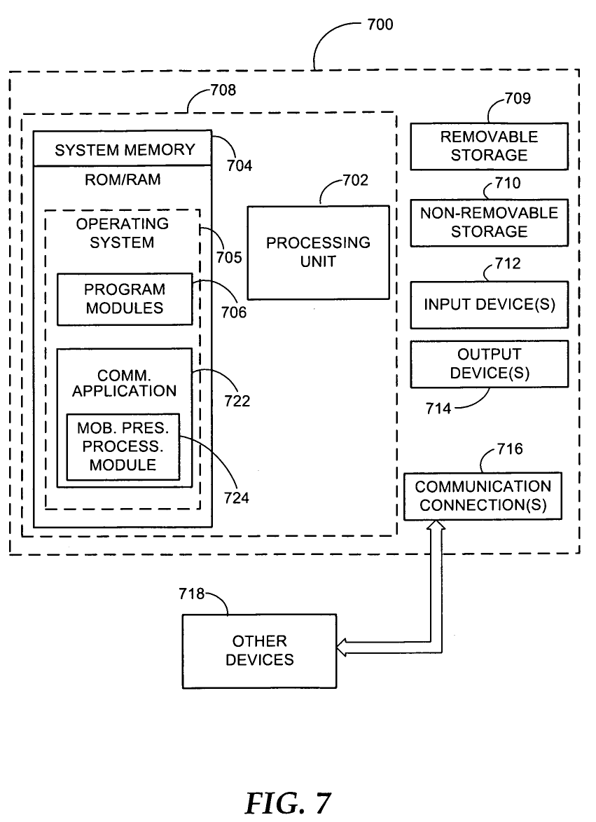

FIG. 7 and the associated discussion are intended to provide a brief, general description of a suitable computing environment in which embodiments may be implemented. With reference to FIG. 7, a block diagram of an example computing operating environment for an application according to embodiments is illustrated, such as computer 700. In a basic configuration, computer 700 may include at least one processing unit 602 and system memory 704. Computer 700 may also include a plurality of processing units that cooperate in executing programs. Depending on the exact configuration and type of computing device, the system memory 704 may be volatile (such as RAM), non-volatile (such as ROM, flash memory, etc.) or some combination of the two. System memory 704 typically includes an operating system 705 suitable for controlling the operation of the platform, such as the WINDOWS® operating systems from MICROSOFT CORPORATION of Redmond, Wash. The system memory 704 may also include one or more software applications such as program modules 706, communication application 722, and mobile presence processing module 724.

Communication application 722 and mobile presence processing module 724 may be separate applications or integral modules of a hosted service that provides communication services to client applications/devices. Mobile presence processing module 724 may analyze called party mobile presence and movement data received from one or more data source applications. Based on the analysis results, communication application 722 may present detailed information to a user enabling informed selection of communication modes or make automatic communication mode selections. According to other embodiments, the data may be received and analyzed for a number of subscribers in the user's contacts list prior to an indication of a call request by the user. This basic configuration is illustrated in FIG. 7 by those components within dashed line 708.

Computer 700 may have additional features or functionality. For example, the computer 700 may also include additional data storage devices (removable and/or non-removable) such as, for example, magnetic disks, optical disks, or tape. Such additional storage is illustrated in FIG. 7 by removable storage 709 and non-removable storage 710. Computer readable storage media may include volatile and nonvolatile, removable and non-removable media implemented in any method or technology for storage of information, such as computer readable instructions, data structures, program modules, or other data. System memory 704, removable storage 709 and non-removable storage 710 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computer 700. Any such computer readable storage media may be part of computer 700. Computer 700 may also have input device(s) 712 such as keyboard, mouse, pen, voice input device, touch input device, and comparable input devices. Output device(s) 714 such as a display, speakers, printer, and other types of output devices may also be included. These devices are well known in the art and need not be discussed at length here.

Computer 700 may also contain communication connections 716 that allow the device to communicate with other devices 718, such as over a wireless network in a distributed computing environment, a satellite link, a cellular link, and comparable mechanisms. Other devices 718 may include computer device(s) that execute communication applications, GPS satellites providing GPS data, cellular towers providing external data and/or positioning data, and comparable devices. Communication connection(s) 716 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

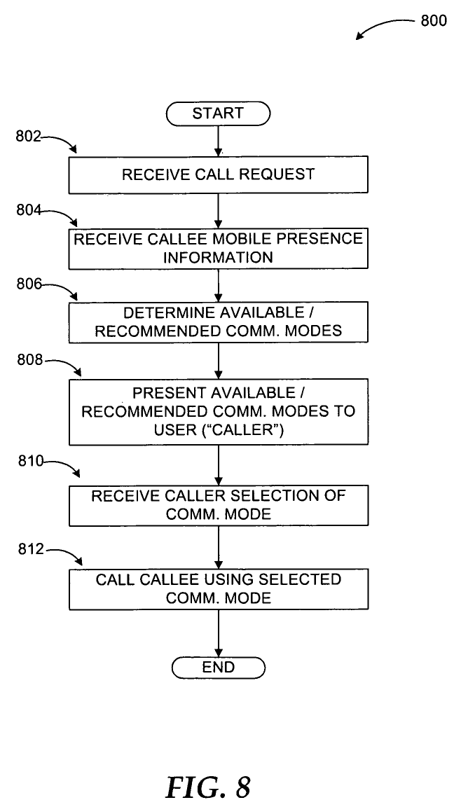

FIG. 8 illustrates a logic flow diagram 800 for using called party's mobile status in facilitating communications according to embodiments. Process 800 may be implemented as part of a unified communication system communicator application such as the one described above in conjunction with FIGS. 3 and 4.

Process 800 begins with operation 802, where a call request is received from a subscriber of a communication network/service. At subsequent operation 804, mobile presence information associated with the called party identified in the call request is received. The mobile presence information may include a location of the called party, a speed of the called party, and/or a direction of the called party's movement. This information may be received from the called party's communication device, a server associated with the communication network, and/or other sources such as a GPS server, a cellular network information server, and similar devices.

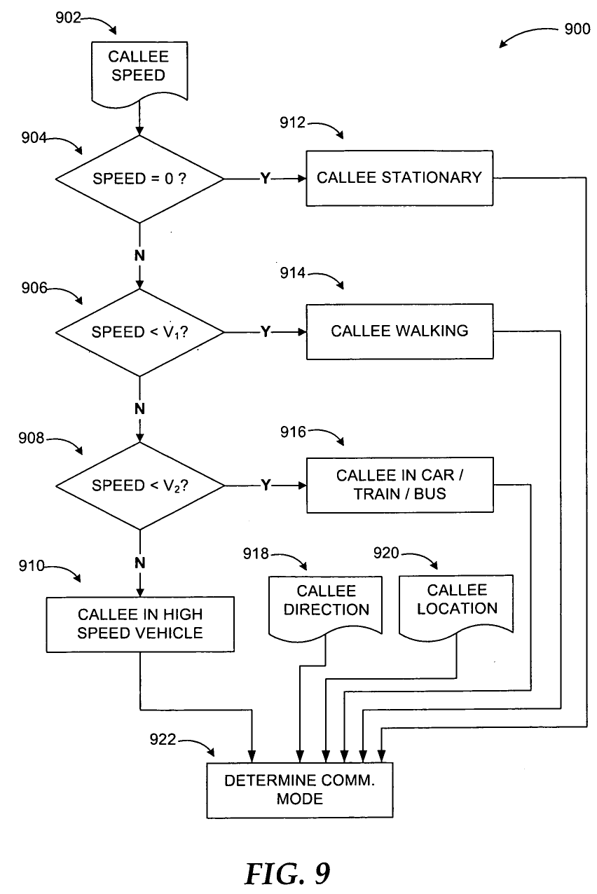

At operation 806 following operation 804, available and/or recommended communication modes are determined based on the information received at operation 804. Details of this operation are discussed below in FIG. 9. According to other embodiments, the mobile presence information associated with a number of contacts may be received (e.g. subscriber in a contacts list) without waiting for the call request and communication modes determined for each of those contacts.

At operation 808, the available and/or recommended communication modes are presented to the caller as shown in the example screenshots of FIG. 4 and FIG. 5. Operation 808 is followed by operation 810, where a caller selection of a communication mode for the called party is received. Subsequently, at operation 812, communication with the called party is established using the selected communication mode. After operation 812, processing moves to a calling process for further actions.

FIG. 9 illustrates a logic flow diagram 900 for determining available communication modes based on called party's mobile status according to embodiments. The process shown in FIG. 9 is based on a speed of a called party. However, embodiments are not limited to speed-based mobile status as discussed previously. Other parameters, information, and information sources may be utilized to determine mobile status such as environment, device type, and similar ones using the principles described herein. Process 900 includes example detail operations for performing operation 806 of process 800 in FIG. 8.

Process 900 includes three inputs: called party's speed information 902 feeding into decision operation 904 and called party's direction and location information 918, 920 feeding into operation 920. At decision operation 904, a determination is made whether the speed is about zero. If the speed is zero, processing continues to operation 912, where the called party is designated as stationary. This information coupled with called party location information 920 may help the caller determine whether the called party is temporarily in a place (e.g. cafeteria) or for a longer period (e.g. office). Of course the information may be processed according to circumstances such as a called party waiting in traffic not being interpreted as stationary (e.g. in the office).

If the speed is not zero, another determination is made at decision operation 906 as to whether the speed is lower than a first predefined threshold (V₁). This first threshold may be set to distinguish human motion from vehicle motion. Thus, if the speed is determined to be less than V₁, the called party may be designated as walking at operation 914. This information coupled with the called party direction and location information (918, 920) may help the caller determine whether the called party is, for example, walking away from the office or approaching the office, walking between offices, etc.

If the speed is greater than V₁, a third determination may be made at decision operation 908 as to whether the speed is less than a second threshold V₂. The second threshold may be predefined to distinguish a category of vehicles from others, for example cars/buses/trains from planes. Thus, if the speed is less than V₂, the called party may be designated as travelling in a car, bus, or train (916). That designation may be complemented or enhanced by additional information received from another source such as network information associated with an on-train wireless network. This information coupled with the called party direction and location information (918, 920) may also help the caller determine whether the called party is, for example, driving away from the office or approaching the office.

If the speed is determined to be higher than V₂, the called party may be designated as travelling in a high speed vehicle such as a plane (910). With an increasing number of airlines allowing in-flight wireless communication, a variety of communication modes may also be available even when the called party is on a plane.

The designation of called party's mobile status in one of the operations 912, 914, 916, or 910 coupled with inputs 918 and 920 result in the determination of the available/recommended communication mode(s) at operation 920.

The operations included in processes 800 and 900 are for illustration purposes. Using mobile presence information in determining communication modes may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for utilizing mobile presence information in a communication application, the method comprising:
receiving mobile status information associated with a first subscriber;
determining at least one available communication mode between the first subscriber and a second subscriber based on the mobile status information;
presenting the at least one available communication mode to the second subscriber; and
in response to receiving a selection of communication mode from the second subscriber, establishing communication between the first and second subscribers employing the selected communication mode.

2. The method of claim 1, wherein the mobile status information is based on at least one from a set of: whether the first subscriber is in motion, the first subscriber's speed, the first subscriber's direction, and the first subscriber's location.

3. The method of claim 1, wherein the mobile status information is determined by a communication application associated with the first subscriber based on input from at least one external resource and at least one local resource, and provided to another communication application associated with the second subscriber.

4. The method of claim 3, wherein the external resource includes one of: a Global Positioning Service resource, a cellular communication service resource, and a wireless network identification resource, and wherein the local resource includes one of: a motion sensor and a speed sensor.

5. The method of claim 1, wherein the mobile status information is determined by a communication application associated with the second subscriber based on input from another communication application associated with the first subscriber and at least one external resource.

6. The method of claim 1, wherein the mobile status information indicates for the first subscriber one from the following: stationary, walking, traveling in a slow moving vehicle, traveling in a fast moving vehicle, and traveling in an airplane.

7. The method of claim 7, wherein the mobile status information further indicates for the first subscriber one from the following: traveling in a car and traveling in a public transportation vehicle.

8. The method of claim 1, wherein the mobile status information is provided to the second subscriber upon one of: expiration of a predefined time period and a change in the mobile status of the first subscriber.

9. The method of claim 1, wherein the mobile status information is provided to the second subscriber upon receiving a request from the second subscriber for establishing communication with the first subscriber.

10. The method of claim 1, further comprising:
adjusting at least one communication parameter based on the mobile status information upon establishment of the communication between the first and second subscribers.

11. A system for utilizing mobile presence information in providing communication services, the system comprising:
a server and a communication management framework, the server configured to execute the communication management framework and further configured to:
determine mobile status information for a first user and a second user based on receiving at least one from a set of: location information, speed information, and direction information associated with the first and second users from a remote resource and a local resource;
determine available communication modes between the first user and the second user based on the mobile status information;
provide available communication modes to the first and second users; and
in response to receiving a selection of one of the available communication modes from one of the first user and the second user, facilitate communication between the first and second users employing the selected communication mode;
a first communication application associated with the first user configured to:
publish mobile presence including information associated with a mobile status of the first user to the communication management framework; and
present the available communication modes to the first user for selection; and
a second communication application associated with the second user configured to:
publish mobile presence including information associated with a mobile status of the second user to the communication management framework; and
present the available communication modes to the second user for selection.

12. The system of claim 11, wherein the server is further configured to present the available communication modes along with a recommendation based on a mobile status of a called user.

13. The system of claim 12, wherein the available and recommended communication modes are presented employing at least one from a set of: a graphical shape-based scheme, an icon scheme, a color scheme, and a text-formatting scheme.

14. The system of claim 11, wherein the first and second communication applications facilitate communications over at least one from a set of: a wireless short range network, a wireless long range network, a cellular network, a Public Switched Telephone Network (PSTN), a satellite assisted network, and a wired data network.

15. The system of claim 11, wherein the communication modes include at least one from a set of: voice communication, video communication, instant messaging, application sharing, data sharing, and whiteboard exchange.

16. The system of claim 11, wherein the first and second communication applications are executed on at least one from a set of: a smart phone, a laptop computer, a desktop computer, a handheld computer, and a smart automobile console.

17. A computer-readable storage medium having instructions stored thereon for using mobile presence information in establishing communications, the actions comprising:
determining mobile status information for a first user based on receiving at least one from a set of: location information, speed information, and direction information associated with the first user;
publishing the mobile status information as mobile presence associated with the first user that includes one of: stationary, walking, traveling in a slow moving vehicle, traveling in a fast moving vehicle, and traveling in an airplane;
determining at least one available communication mode between a second user and the first user based on the mobile presence of the first user;
presenting the at least one available communication mode to the second user; and
in response to receiving a selection of communication mode from the second user, facilitating communication between the first and second subscribers employing the selected communication mode.

18. The computer-readable storage medium of claim 17, wherein the instructions further comprise:
presenting a recommended communication mode among the available communication modes based on the mobile presence of the first user by de-emphasizing textual indication of non-recommended communication modes.

19. The computer-readable storage medium of claim 18, wherein the instructions further comprise:
presenting the available communication modes and the recommended communication mode further includes employing a graphical color scheme indicating availability and capabilities of the communication modes.

20. The computer-readable storage medium of claim 18, wherein the instructions further comprise:
automatically establishing communication between the first and second subscribers employing the recommended communication mode.
